(19) United States
(12) Patent Application Publication
(10) Pub. No.: US 2015/0080072 A1
(43) Pub. Date: Mar. 19, 2015

(54) KARAOKE AND DANCE GAME

(71) Applicant: YOUNG DAE KIM, Seoul (KR)

(72) Inventor: Young Dae Kim, Seoul (KR)

(21) Appl. No.: 14/386,571

(22) PCT Filed: Mar. 15, 2013
(86) PCT No.: PCT/KR2013/002080

§ 371 Date: Sep. 19, 2014

(30) Foreign Application Priority Data
Mar. 20, 2012 (KR) 10-2012-0028045

(51) Int. Cl. A63F 13/814; A63F 13/213; G06T 15/00

(52) U.S. Cl. CPC A63F 13/814; G06T 15/005; A63F 13/213
USPC 463/7

(57) ABSTRACT

The present invention relates to a karaoke and dance game system comprising: a karaoke device which comprises an image display device, a speaker and a microphone, and which has a subtitle display function and video mixing function; a camera for photo-graphing an object; an infrared camera for scanning the object; a three-dimensional (3D) image generation device for generating a 3D graphic including a plurality of virtual studio images and a 3D virtual studio for performing chroma keying of an image outputted from the camera by a 3D acceleration graphic card and 3D-texturing only an actual object to perform 3D space processing, and calculating per-pixel distance information according to the infrared rays reflected from the object and 3D-rendering an image of the 3D video generation device to output a 3D virtual image.

### CROSS REFERENCE TO RELATED APPLICATION

The application claims foreign priority benefits of Korean Patent Application Serial No.: 10-2012-0028045, filed on Mar. 20, 2012, which is incorporated by reference in its entirety into this application.

### TECHNICAL FIELD

The present invention relates to a karaoke dancing game, and in particular to a karaoke dancing game which makes it possible to display a user and a user's motion on a screen in 3D images and evaluate the user's motions in a form of scores by analyzing the user's motions.

### BACKGROUND ART

A conventional karaoke system is configured for a user to sing a song, seeing a screen mixed with a music and a background. In recent years, there is a new karaoke system characterized in that a video mixed using a video chroma-key technology is inputted in a karaoke system.

Furthermore, as another conventional karaoke system (refer to reference document 1), there is a karaoke system which uses a three dimensional (3D) virtual studio. The conventional karaoke system which uses a 3D virtual studio comprises a karaoke device including an image display device, a speaker and a microphone along with a subtitle display function and a video mixing function; a camera configured to photograph a predetermined object; a 3D video generation device configured to generate a 3D graphic including a plurality of virtual studio images; and a 3D virtual studio configured to output a 3D virtual image by mixing the video from the camera and the video from the 3D video generation device. In the above construction, the images outputted from the 3D virtual studio are inputted as the background images of the karaoke device.

When a singer sings with a karaoke system, it may be possible to make ambience more fun in such a way to provide an image showing the singer actually singing and dancing on a reality-like stage.

The inventor of the present application, which will be descried in details hereinafter, has invented a karaoke game system characterized in that an object corresponding to a singer may be displayed on a karaoke screen in a video chroma-key technology, and an image from a 3D video generation device may be displayed as a background, so a user may feel like singing among a variety of 3D images.

When a user wants to learn or practice dancing, most of such users must learn or practice from a teacher or using a recorded image tape. In this case, it costs a lot to learn or practice from a teacher while entailing some limitations in terms of time. In case that the user practices using a recorded image tape, the user may become easily boring, so the conventional ways may easily fail to obtain efficient dancing practices.

In consideration of the above-described problems, there may be a predetermined demand for a system which may help a user alone learn dancing and evaluate the dancing that the user has performed.

### PRIOR ART DOCUMENTS

### Patent Documents

Korean Patent Publication No. 10-0619494

### DISCLOSURE

The simplified descriptions on at least one embodiment will be provided below so as to help understand basic principle of the embodiments of the present inventions. The sections below should not be understood as including all the possible embodiments and as identifying a key element among all the elements and covering the scopes of all the embodiments. The unique object of the descriptions below should be understood as just an introduction for the detailed descriptions so as to provide a basic concept of at least one simplified embodiment.

The present invention is made in an effort to resolve the problems encountered in the conventional art. It is an object of the present invention to provide a karaoke dancing game system characterized in that a user may learn a predetermined dance to the motion of a character provided from a dancing karaoke game system without help from a teacher or a lecturer, and a music image may be manufactured in such a way to record in real time a procedure during a user dances and sings along the characters.

It is another object of the present invention to provide a karaoke dancing game system characterized in that it may provide a health fitness function for a user to enjoy exercise while dancing.

To achieve the above objects, there is provided a dancing karaoke system, comprising a karaoke device which includes an image display device, a speaker and a microphone and has a subtitle display function and a video mixing function; a camera configured to photograph an object; an infrared ray camera configured to scan the object; a 3-dimensional (3D) image generation device configured to generate a 3D graphic including a plurality of virtual studio images; and a 3D virtual studio which is configured to chroma-key using a 3D acceleration card an image outputted from the camera and 3D texture only the actual object and process it into a 3D space and calculate a distance information per pixel in accordance with an infrared ray reflected on the object and render, into a 3D, the image of the 3D video generation device for thereby outputting a 3D virtual image.

In addition, the dancing karaoke game system according to the present invention further comprises a database which comprises data corresponding to dancing motions; and a score calculation unit configured to compare the dancing motions of the object with the dancing motions stored in the database and evaluate the dancing motions in a form of score.

To achieve the above objects, there is provided a method for providing a dancing karaoke, comprising photographing the dancing motions of an object using a camera; scanning the dancing motions of the object using an infrared ray camera; creating a 3-dimensional (3D) graphic including a plurality of virtual studio images; and chroma-keying the photographed object using a 3D acceleration graphic card, 3D-texturing only the actual object, processing it in a 3D space, calculating a distance information per pixel by recognizing an infrared ray reflected on the object and 3D-rendering the created 3D graphic and outputting a 3D virtual image.

The method for providing a dancing karaoke game according to the present invention further comprises comparing the dancing motions of the object with the dancing motions stored in the database and evaluating the dancing motions in a form of scores.

As an alternative example of the present invention, there is provided a dancing karaoke system which comprises a first image display device configured to display a song lyrics and a dance corresponding to the song for the sake of a singing and dancing user; a karaoke device which includes a second image display device, a speaker and a microphone and has a subtitle display function and a video mixing function; a camera configured to photograph the image of the singing and dancing user and recognize the motions of the singing and dancing user; a 3D video generation device configured to create a 3D graphic of the 3D video generation device; and a 3D virtual studio configured to chroma-key the photographed image of the singing and dancing user into the virtual studio image of the 3D video generation device and output a 3D virtual image on the second image generation device.

As an alternative example of the present invention, the dancing karaoke system further comprises a database which comprises data corresponding to dancing motions; and a score calculation unit configured to compare the recognized motions of the singing and dancing user with the dancing motions stored in the database.

### Advantageous Effects

According to the present invention, a user's dancing motion may be compared in real time precisely with a character or an image in such a way that the motion data of a variety of characters are in real time inputted in a 3D space so as to show them in a variety of postures, and a user's dancing motion is in real time mixed with the postures, and the mixed videos are displayed.

The present invention is directed to allowing a user to learn dancing alone to the motion of a character provided from a system without a dance lecturer and to manufacture a music image by in real time recording a user's singing and dancing motion while the user sings and dances along with the characters for thereby providing a fun dancing and healthy exercise effect.

According to the construction of the present invention, the user's dancing motions may be compared with the dancing motions stored in a database and may be evaluated in a form of scores, so the user may learn dancing while naturally enjoying game and exercise.

In order to achieve the above described objects and related other objects, at least one embodiment will be described below along with the features recited in claims. Exemplary aspects of the present invention may be well be understood along with the descriptions and drawings below. It should be understood that such aspects are provided for only illustrations, and it is obvious that those skilled in the art may pursue a variety of modifications. The disclosed embodiments should be interpreted as including the above embodiments and all the equivalents of such embodiments.

### BRIEF DESCRIPTION OF DRAWINGS

Some of features may not be illustrated customarily based on actual sizes. The dimensions of such features, therefore, may be randomly enlarged and contracted for the sake of simplification. It is also noted that part of the drawings may be simplified for simplification. The drawings below may not illustrate all the components of the disclosed devices or the method. Finally, similar reference numbers may be used to similar features throughout the detailed descriptions and drawings.

FIG. 1 is a block diagram illustrating a dancing karaoke system according to an embodiment of the present invention.

FIG. 2 is a block diagram illustrating an image generation device according to an embodiment of the present invention.

FIGS. 3 to 5 are views illustrating the procedures for scanning a user's motion information using an IR (Infrared Ray) camera according to an embodiment of the present invention.

FIG. 6 is a view illustrating a state that a user is displayed on a karaoke screen according to an embodiment of the present invention.

FIG. 7 is a view illustrating a user's skeleton so as to evaluate a user's dancing motion in a form of scores according to an embodiment of the present invention.

FIG. 8 is a flow chart so as to provide a dancing karaoke game system according to an embodiment of the present invention.

### BEST MODES FOR CARRYING OUT THE INVENTION

Various embodiments of the present invention will be described with reference to the accompanying drawings. Similar reference numbers represent similar components throughout all the drawings. A variety of descriptions may be used for understanding better the present invention. It is obvious that such embodiments may be implemented without any specific descriptions. In other examples, known structures and apparatuses are provided in the forms of block diagrams for easier descriptions.

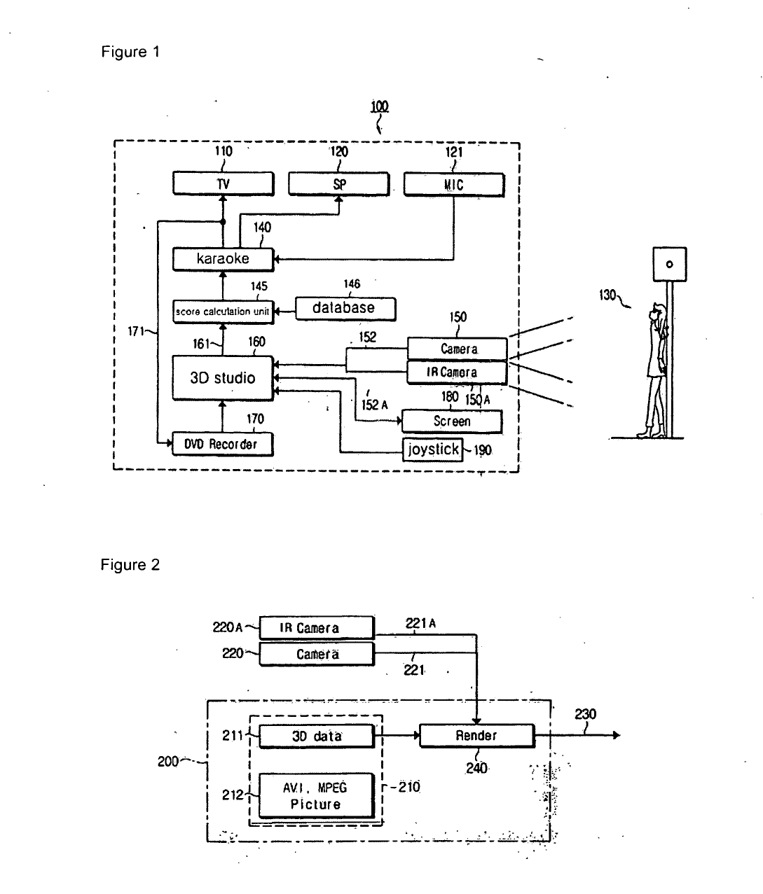

FIG. 1 is a block diagram illustrating a dancing karaoke system according to an embodiment of the present invention.

Referring to FIG. 1, the dancing karaoke game system 100 according to an embodiment of the present invention comprises an image display device (TV) 110, a speaker 120, a microphone (Mic) 121, a karaoke system 10, a score calculation unit 145, a database 146, a camera 150, an IR camera (IR camera) 150a, a 3D virtual studio 160, a reproducible and recordable DVD recorder 170 (hereinafter referred to an image recording and playback device), a screen controller (screen control) 180 and a joystick 190. Among the above described components, the TV 110, the speaker 120, the microphone 121 and the karaoke system 140 are same as the conventional karaoke system, so the descriptions thereof will be omitted.

The image recording and playback device 170 is configured to record the final images displayed on the image display device 110 based on a user's selection.

The camera according to the present invention is configured to photograph an image of an object and recognize the motion of the object. The camera according to the present invention may be a typical image photographing device and a distance recognition device which may recognize a distance to a photographing device of a depth object such as an IR camera.

The camera 150 is configured to photograph a predetermined object 130 and output an image 152 of the object 130. The IR camera 150a is configured to measure a distance per pixel by scanning the object 130 using an infrared ray.

The screen controller 180 is configured to control forming a screen on which to select one among the images from a plurality of the virtual cameras (not shown) and the previously set virtual studio images (background, etc.)

The joystick 190 is configured to adjust the virtual camera selected by the screen controller 180 and input the adjustment data into the 3D virtual studio 160.

The 3D virtual studio 160 may be a 3D virtual studio system. The conventional 3D virtual studio is configured to form a virtual studio using a 3D image generation technology and a technology for mixing camera videos. More specifically, the 3D virtual studio 160 is configured to mix videos in such a way that a graphic generation apparatus forms and mixes a background and a panorama both corresponding to the positions of the cameras by naturally mixing a 3D image created using graphics with the image of an actor which is inputted from the camera and by forming a screen wherein a user may feel like an actor is actually in a studio and by reading through a sensor the motions of the cameras. In details, the graphic generation apparatus generates the information of the images of the front and rear sides of the actor based on the images of the actual cameras so as to generate 3D virtual spaces, and the generated information is made into the forms of graphics based on the positions of the cameras, and the graphics are mixed. The above described method may require a dual form of the graphic generation device and a tracking device for forming an external camera tracking information which accurately shows the positions of the moving camera, and cost increases. In addition, the camera tracking sensor requires a user's setup and a complicated operation and equipment setup procedure, so there may be difficulties for using 3D graphics. In consideration of the above mentioned problems, an embodiment of the present invention is directed to providing a 3D virtual studio system using a virtual overlay technology which is characterized in that the number of the rendering equipment requiring a common virtual studio technology may be saved, and the high costs due to the use of the equipment which requires camera tracking may not be necessary, and a user's difficult environment may be eliminated, and the user may easily and conveniently use the system of the present invention along with simplified construction and low costs. More specifically, the virtual overlay processes the image in the 3D rendering engine as one object, not that the background image and the front image are overlaid in the camera using the conventional mixer, so it is possible to obtain an effect of using two rendering with the aid of one rendering engine and an effect of using an external overlay mixer, so the cost for equipment may be saved, and the environments for use may be simplified. Referring to FIG. 2, the 3D virtual studio block using the virtual overlay technology will be described. The render 240 provides a function of generating in real time the images using the 3D video generation device 210. By using the 3D data generated by an editing program such as a 3D Studio Max or MAYA which is a 3D program for creating a 3D object, the 3D vide generation device 210 outputs in real time the images inputted from the actual camera and the motion pictures (AVI, MPEG, etc.) which are previously prepared, onto the surface of the 3D object based on the image texturing technology. Therefore, it is possible to process and output the rendering at one time along with the images of the camera without using the front and rear surface image generation apparatus which is used to form ordinary 3D images.

The virtual overlay technology is characterized in that the camera image 221 from the camera 220 and the 3D data of the 3D video generation device 210 in the 3D acceleration graphic card 200 are concurrently inputted into the render 230 and are graphically processed in a 3D and are outputted in the form of an analog image 230. More specifically, by using the 3D graphic function of the 3D acceleration graphic card 200, the camera image 221 is inputted into the 3D generation device, namely, into the image texture of the render 240, and the 3D data of the 3D video generation device 210 is concurrently rendered in a 3D form and is outputted in the form of an analog image 230.

The virtual camera selected by the screen controller 180 is adjusted in accordance with a camera adjusting signal (zoon in/out, angle, etc.) inputted from the joystick 190 and outputs an image corresponding to the position of the virtual camera. The virtual camera may be adjusted using the 3D image texturing technology. For this, when the position (position of the camera) of an observer is outputted as an image which may be seen at a predetermined position in the 3D space, the character may be easily positioned in the virtual space using the 3D graphic device, and the virtual cameras may be freely seen from other positions. The screens, therefore, may be changed in real time in a variety of directions, so it is possible to create a motion effect of the camera without using an expensive camera motion device. When the virtual cameras are used in multiple numbers, it is possible to create the same effects as when using multiple cameras.

The operations of the karaoke using a 3D virtual studio according to the present invention will be described.

First of all, when a user turns on the karaoke 140, the karaoke 140 turns on the television 110, the speaker 120 and the microphone 121 and operates the 3D virtual studio 160. When the 3D virtual studio 140 renders, in a form of 3D, in the render 240 of the 3D acceleration graphic card 200, the previously set virtual studio images (background screen—not show in the drawings) and the images of the object (the user) photographed by the cameras and outputs to the karaoke 140, the karaoke 140 mixes the lyrics into the inputted virtual studio images 161 and outputs the images to the television 110 and outputs an accompaniment music through the speaker 120, so the user may sing a song into the microphone 121 listening the background music outputted on the screen of the television 110 and watching himself/herself singing a song and the lyrics. In addition, the user may select a desired background image in such a way to change the previously set virtual studio image by adjusting the screen control 180 and outputs the selected one. At this time, the user or other audience may freely change the images displayed on the television 110 in such a way to freely change in a form of 3D the virtual studio images or the images photographed by the camera 150 by adjusting the positions of the virtual cameras using the joystick 190. Therefore, it is possible create a tracking effect without using a tracking sensor, and it is possible to easily position the user into the virtual image using the 3D graphic device. Since the virtual camera may be adjusted, it is possible to change in real time the screen in a variety of directions. Since the virtual cameras may be positioned in multiple numbers, it is possible to create the same effects as when using multiple cameras.

According to an exemplary embodiment of the present invention, the distance per pixel may be measured in such a way that the IR camera 150a scans the objects using an infrared ray, so the dancing motions of the user may be recognized using such a function.

According to an exemplary embodiment of the present invention, the 3D virtual studio may comprise an image software configured to recognize the motions of the object in such a way to process the depth information.

In the score calculation unit 145, the recognized dancing motions of the user may be compared with the dancing motions stored in the database 146, so the dancing motions of the user may be evaluated in a form of scores. In addition, the database 146 may store a variety of characters which may appear as the background of the user.

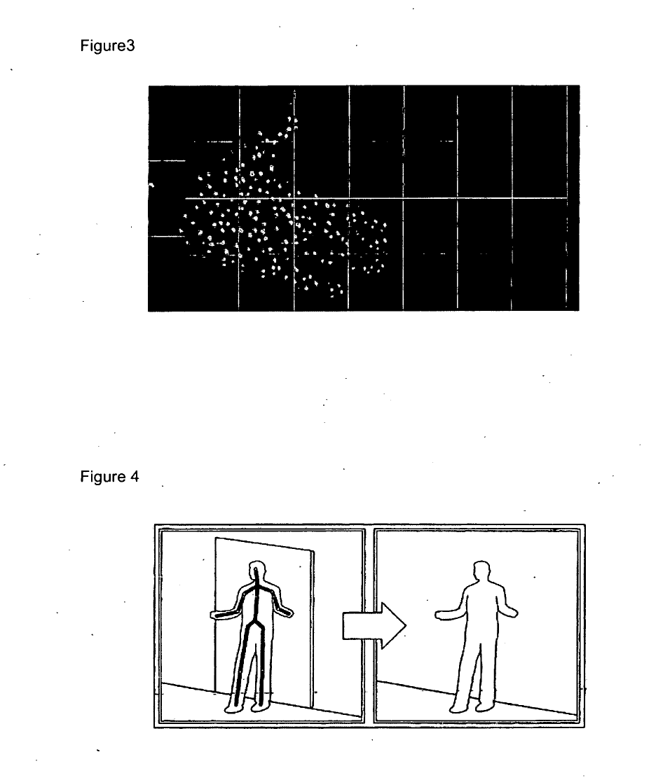

FIGS. 3 to 5 are views illustrating a procedure for scanning the user's motions information using the IR camera 150a according to an embodiment of the present invention.

FIG. 3 is a view illustrating the screen showing that an infrared ray is reflected on a user's hand. When the infrared ray from the IR camera 150a is reflected on a user's hand, the image software included in the 3D virtual studio 160 analyzes the reflected pixels for thereby recognizing the dancing motions of the user.

FIG. 4 is a view illustrating a key part of joints showing the user's gestures using the IR camera 150a. It is possible to recognize the dancing motions of the user because the key joints corresponding to a user's face, neck, arms and legs may be recognized, and the motions of the key joints may be recognized.

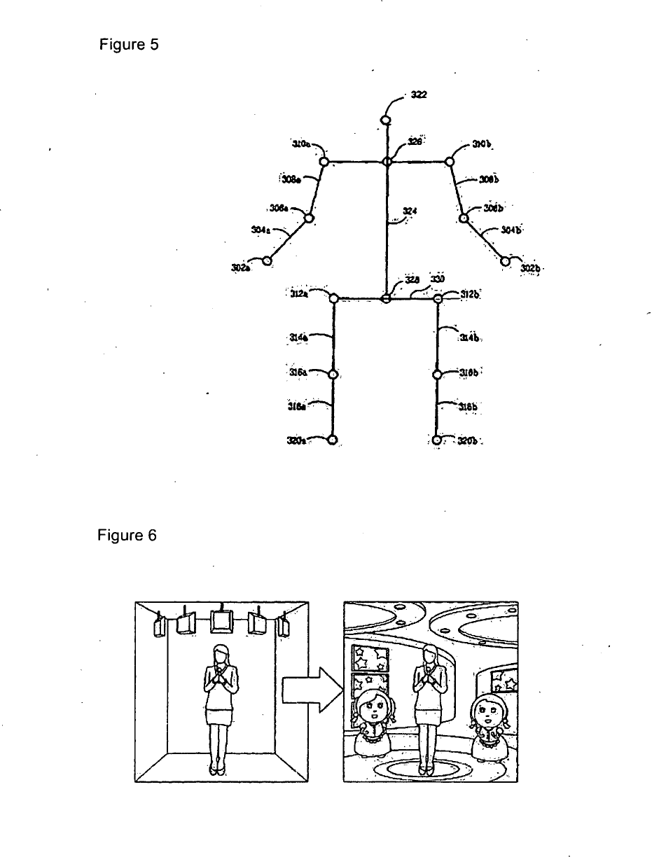

FIG. 5 is a view illustrating a state that a user is shown on the display screen in accordance with the recognitions of the user's key joints of FIG. 4.

FIG. 6 is a view illustrating a state that a user is shown on the karaoke screen according to an embodiment of the present invention.

As show in FIG. 6, according to the dancing karaoke game system according to an embodiment of the present invention, the image showing the user singing and dancing with a chroma-key-processed background behind the user is photographed using the camera 150 and is mixed with the 3D image, and at the same time, the dancing motions of the user may be recognized using the IR camera 150a.

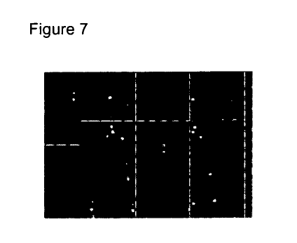

FIG. 7 is a view illustrating user's scanned joints so as to evaluate in a form of scores the dancing motions of the user according to an embodiment of the present invention.

The dancing motions of the user may be recognized based on the information obtained by scanning the user's skeleton. The score calculation unit 145 compares the recognized dancing motions with the dancing motions stored in the database 146 for thereby evaluating the dancing motions of the user in a form of scores.

For example, the score calculation unit 145 is characterized in that the dancing motions of the user may be evaluated in a form of scores in such a way that if the arm motion of the user, for example, does not move to time, five scores may be deducted, and if the angle of the arm, for example, is not accurate, 10 scores may be deducted assuming that according to the standard dancing motions stored in the database 146 based on the recognitions of the user's arm motions, the right arm is supposed to be lifted at an angle of 90° about the right elbow joint to the time of a predetermined background music, and the left arm is supposed to be lifted at an angle of 90° about the left elbow joint.

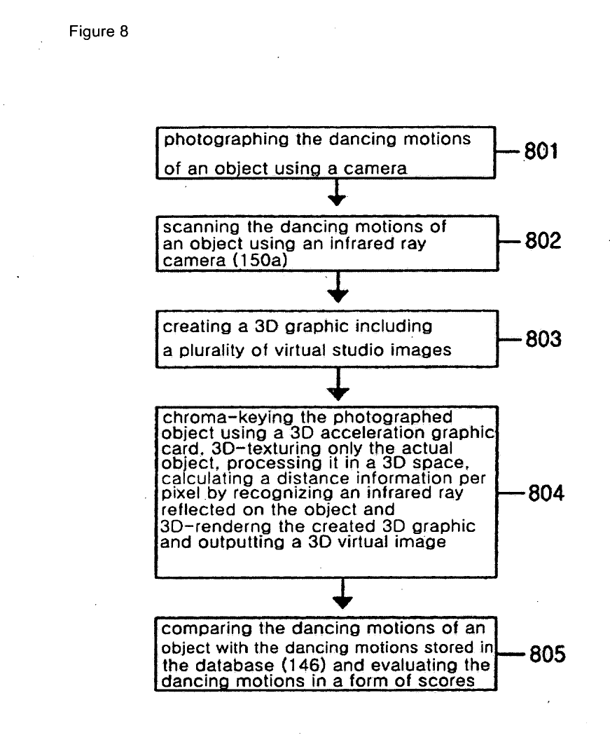

FIG. 8 is a flow chart for describing a method for providing a dancing karaoke game according to an embodiment of the present invention.

First of all, there is a step 801 wherein the dancing motions of the object are photographed using the camera. The camera 150 is configured to photograph a predetermined object with the chroma-key background behind it for thereby photographing the images which may be inputted into the 3D studio.

In a step 802, the dancing motions of the object may be scanned using the IR camera 150a. The key joints of the object may be recognized in such a way that the IR camera 150a radiates infrared rays.

In a step 803, a 3D graphic including a plurality of virtual studio images may be created. The plurality of the virtual studio image may be used for mixing into a background screen of the user.

In a step 804, the 3D acceleration graphic card performs a 3D space process by chroma-keying the photographed object and 3D texturing the actual object, and the infrared ray reflected on the object is recognized for thereby calculating the distance information per pixel and at the same time outputting a 3D virtual image by 3D rendering the created 3D graphics. The object photographed by the camera 150 is mixed with the 3D image and is outputted, and the infrared ray reflected on the object is recognized for thereby calculating the distance information per pixel, so it is possible to recognize the dancing motions of the object by the IR camera 150a.

In a step 805, the score calculation unit 145 compares the dancing motions of the object with the dancing motions stored in the database 146 for thereby evaluating in a form of scores.

According to the above described constructions, the motion data of a variety of characters are inputted in real time into a 3D space for thereby showing a variety of postures, and at the same time such data are mixed in real time with the dancing motions of the user himself for thereby also showing them, so the user may compare in real time the dancing motions of the user himself with the characters or image scenes.

Therefore, the user may learn following the motions of the characters provided on the system without a dance lecturer and may dance and sing along with the characters and may produce in real time a music image which contains his own dancing motions, so the user may do exercise dancing joyfully by using the present invention as an exercise apparatus.

In addition, according to the construction of the present invention, the user may compare the dancing motions himself with the dancing motions stored in the database and may evaluate it in a form of scores, so the user may learn how to dance enjoying the game, naturally doing exercise.

The construction of the present invention may be a component, a module or a system. The terms “component”, “module”, “system” used throughout the specification of the present invention represents a computer-related entity, a hardware, a firmware, a software, a combination of software and hardware or an execution of the software. For example, the component may be a processing procedure executed on the processor, a processor, an object, an execution thread, a program and/or a computer, but it is not limited thereto. For example, all the applications executable on the computing devices and the computing devices may be components. At least one component may reside in the processor and/or execution thread. One component may be localized on one computer or may be distributed to at least two computers. The above mentioned components may be executed by a variety of computer readable medium which contain a variety of data structures stored therein. The components, for example, may be communicated through a local and/or remote process in accordance with a signal having at least one data packet (for example, the data from one component interacting with another component on a local system and a distribution system and/or the data through a network like the internet by way of signals).

According to at least one exemplary embodiment of the present invention, the above described functions may be implemented by means of a hardware, a software, a firmware or a combination thereof. In case that it is implemented with a software, the above mentioned functions may be at least one commands operable on the computer readable medium or may be stored as codes or may be transmitted through them. The computer readable medium comprises a computer storable medium, and a communication medium including a predetermined medium allowing a transfer of a program from one place to another place. Here, the storage medium may be a predetermined available medium which may be accessible by a universal type computer or a specially designed computer. For example, the computer readable medium may be RAM, ROM, EEPROM, CD-ROM or other optical disk storage medium, a magnetic storage medium or other magnetic storage devices or a predetermined medium which may be used as a program code means having a command or data structure and may be assessable by a universal computer, a specially designed computer, a universal processor or a specially designed processor, but it is not limited thereto. In addition, a predetermined connection means may be identified as a computer readable medium. For example, in case that the software is transferred through a wireless communication technology such as a coaxial cable from a website, a server or other remote source, an optical fiber cable, a stranded cable, a digital subscriber line (DSL) or an infrared ray radio and a microwave, such as a wireless communication technology through the coaxial cable, the optical fiber cable, the stranded cable, the DSL, or the infrared ray radio and the microwave may be included in the range of the definition of the above mentioned medium. The disk and disc include a compact disc, a laser disc, an optical disc, a DVD, a floppy disk, and a blue-ray disc. Here, the disk is configured to magnetically reproduce data, but the disc is configured to optically reproduce the data by way of laser. A combination of the disk and the disc may be included in the range of the computer readable medium.

The database 146 according to the present invention may be a volatile memory or a nonvolatile memory or may be both a volatile memory and a nonvolatile memory. As an example which is not limited thereto, the nonvolatile memory may comprise a read only memory (ROM), a programmable ROM (PROM), an electrically programmable ROM (EPROM), an electrically erasable PROM (EEPROM) or a flash memory. The volatile memory may comprise a random access memory (RAM) which operates by an external cache memory. As an example which is not limited thereto, the RAM may be a synchronous RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM) and a direct Rambus RAM (DRRAM).

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A dancing karaoke system, comprising:
a karaoke device which includes an image display device, a speaker and a microphone and has a subtitle display function and an image mixing function;
a camera configured to photograph an object;
an infrared ray camera configured to scan the object;
a 3-dimensional (3D) image generation device configured to generate a 3D graphic including a plurality of virtual studio images; and
a 3D virtual studio which is configured to chroma-key using a 3D acceleration card an image outputted from the camera and 3D texture only the actual object and process it into a 3D space and calculate a distance information per pixel in accordance with an infrared ray reflected on the object and render in a 3D the image of the 3D video generation device for thereby outputting a 3D virtual image.

2. The system of claim 1, further comprising:
a database which comprises data corresponding to dancing motions; and
a score calculation unit configured to compare the dancing motions of the object with the dancing motions stored in the database and evaluate the dancing motions in a form of score.

3. A method for providing a dancing karaoke, comprising:
photographing the dancing motions of an object using a camera;
scanning the dancing motions of the object using an infrared ray camera;
creating a 3-dimensional (3D) graphic including a plurality of virtual studio images; and
chroma-keying the photographed object using a 3D acceleration graphic card, 3D-texturing only the actual object, processing it in a 3D space, calculating a distance information per pixel by recognizing an infrared ray reflected on the object and 3D-rendering the created 3D graphic and outputting a 3D virtual image.

4. The method of claim 3, further comprising:
comparing the dancing motions of the object with the dancing motions stored in the database and evaluating the dancing motions in a form of scores.
